(19) United States
(12) Patent Application Publication
(10) Pub. No.: US 2025/0290795 A1
(43) Pub. Date: Sep. 18, 2025

(54) COHERENT DETECTION FOR THE IDENTIFICATION OF SCATTERED LASER LIGHT IN A BRIGHT INCOHERENT BACKGROUND

(71) Applicant: University of Southern California, Los Angeles, CA (US)

(72) Inventors: Jonathan Habif, Los Angeles, CA (US); Andrew Rittenbach, Los Angeles, CA (US)

(73) Assignee: University of Southern California, Los Angeles, CA (US)

(21) Appl. No.: 19/079,287

(22) Filed: Mar. 13, 2025

Related U.S. Application Data
(60) Provisional application No. 63/566,548, filed on Mar. 18, 2024.

(51) Int. Cl. G01J 1/42; G01J 1/02

(52) U.S. Cl. CPC G01J 1/4257; G01J 1/0295

(57) ABSTRACT

A system and method for coherent detection for identification of scattered laser light in a detection region. The system may have an optical sensor that collects a raw optical signal. The optical signal may be mixed with a local oscillator signal to generate a mixed baseband signal. Various processing may be performed on the mixed baseband signal. The system may use the mixed baseband signal to detect whether or not scattered laser light is in the raw optical signal.

### CROSS-REFERENCE TO RELATED APPLICATIONS

This application is based upon and claims the benefit of and priority to U.S. Provisional Patent Application No. 63/566,548, filed on Mar. 18, 2024, entitled “COHERENT DETECTION FOR THE IDENTIFICATION OF SCATTERED LASER LIGHT IN A BRIGHT INCOHERENT BACKGROUND,” the entire content of which is incorporated by reference herein.

### STATEMENT AS TO FEDERALLY SPONSORED RESEARCH

This invention was made with government support under contract number HR001120C0190 awarded by the Defense Advanced Research Projects Agency (DARPA). The government has certain rights in this invention.

### BACKGROUND

### 1. Field

The following disclosure relates to laser light detection, and more specifically, to laser light detection that discriminates scattered laser light from noise.

### 2. Description of Related Art

A laser warning receiver (LWR) is a passive optical detection technology that alerts a user when laser light is incident upon the receiver. LWRs have found military applications in the detection of LADAR systems, and civilian application in alerting drivers to the presence of laser radar operated by law enforcement. Typically, these LWR systems employ direct detection (photon counting) methods for the identification of laser light, relying on the assumption that laser signals, operating in a narrow optical band, will be much brighter than the incoherent environmental background into which the field of view of the LWR is looking. While this assumption is likely valid for a laser directly incident on the LWR, a desirable performance feature would be the ability to detect a laser even before it hits the LWR. The sensitivity to detect laser light scattered from the primary beam via Mie scattering processes would enable such a capability, however Mie processes are highly-directional favoring forward scattering. Therefore optical intensities at large scattering angles (θ_{SC}>10°), and in an environment with natural daylight make direct detection of these scattering processes challenging for typical laser powers and sensor standoff distances. Experiments have demonstrated the detection of atmospherically scattered laser light using direct detection receivers; and, recently, the fundamental quantum limit to discriminating coherent laser light and incoherent noise light was demonstrated. These measurements require ultra-sensitive detectors, narrow-band optical filtering and often operation at nighttime for sufficient noise suppression to perform detection of scattered laser light. Moreover, the requirement for narrowband optical filtering requires that the receiver know, a-priori, the wavelength of the laser for which it is searching, a burdensome demand.

### SUMMARY

A method may be provided for coherent detection for identification of scattered laser light by an optical sensor connected to a processor. The method may include collecting a raw optical signal by the optical sensor. The method may include applying a first high pass filter to the raw optical signal to generate a first filtered signal. The method may include calculating, by the processor, a power spectral density (PSD) of the first filtered signal. The method may include estimating and correcting, by the processor, sloping in a PSD floor of the PSD of the first filtered signal to generate a second filtered signal. The method may include determining a location of maximum value in the second filtered signal. The method may include summing around the location with a fixed window size to generate a first sum. The method may include comparing the first sum to a threshold. The method may include indicating, by the processor, a presence of a laser creating the scattered laser light in response to the first sum exceeding the threshold.

The method may have one or more additional aspect. The system that implements the method may have one or more additional aspect. For instance, in various embodiments, the first high pass filter has a cut-off of about 1 MHz. The first high pass filter may have a cut-off selected to remove lower frequency components that cause an unwanted spike in PSD in an absence of the laser. The first high pass filter may be at least one of (a) a hardware-based filter and/or (b) a software-based filter implemented by the processor. The estimating and correcting may include taking a rolling average of measured PSD and subtracting PSD by the rolling average. The estimating and correcting may include using a calibration measurement from a separate signal known to omit scattered laser light to determine the PSD floor.

A further implementation of the method may be contemplated. For instance, a method may be provided for coherent detection for identification of scattered laser light by an optical sensor connected to a processor. The method may include collecting a raw optical signal by the optical sensor. The method may include applying a first high pass filter to the raw optical signal to generate a first filtered signal. The method may include calculating, by the processor a power spectral density (PSD) of the first filtered signal. The method may include estimating and correcting, by the processor, sloping in a PSD floor of the PSD of the first filtered signal to generate a second filtered signal comprising a processed PSD. The method may include summing the entire processed PSD to generate a first sum. The method may include comparing the first sum to a threshold. The method may include indicating, by the processor, a presence of a laser creating the scattered laser light in response to the first sum exceeding the threshold.

The method may have one or more additional aspect. The system that implements the method may have one or more additional aspect. For instance, in various embodiments, the first high pass filter has a cut-off of about 1 MHz. In various embodiments, the first high pass filter has a cut-off selected to remove lower frequency components that cause an unwanted spike in PSD in an absence of an active laser. The first high pass filter may be a hardware-based filter. The first high pass filter may be a software-based filter implemented by the processor. The first high pass filter may be at least one of (a) a hardware-based filter and/or (b) a software-based filter implemented by the processor. The estimating and correcting may include taking a rolling average of measured PSD and subtracting PSD by the rolling average. The estimating and correcting may include using a calibration measurement from a separate signal known to omit scattered laser light to determine the PSD floor.

An implementation of a system may be provided. The implemented system may be for coherent detection for identification of scattered laser light in a detection region. The system may include an optical sensor to collect a raw optical signal. The system may include a mixer connected to the optical sensor to mix the raw optical signal with a carrier signal generated by a local oscillator source to generate a mixed baseband signal. The system may include an amplifier connected to the mixer to amplify the mixed baseband signal and output a first amplified signal. The system may include a processor connected to the amplifier to receive the first amplified signal and to perform a first signal processing operation to detect a presence or an absence of the scattered laser light in the detection region.

The system may have one or more additional aspect. The local oscillator source may be a continuous-wave laser. The local oscillator source may be one of a non-cooperative tunable laser, an optical frequency comb with an engineered spectrum, and/or a continuous wave laser with a time-modulated amplitude and phase. The local oscillator source may be a phase modulator driven by a laser and a waveform generator, wherein the carrier signal generated by the local oscillator source is not continuous wave. The local oscillator source may at least one of (1) phase modulate and/or (2) amplitude modulate the carrier signal that is mixed by the mixer with the raw optical signal.

In various instances of the system the first signal processing operation includes further aspects. For instance, in various embodiments, the first signal processing operation may comprise using a convolutional neural network (CNN) to implement the signal processing algorithm via machine learning. The first signal processing operation may include calculating, by the processor, a power spectral density (PSD) of the first amplified signal. The first signal processing operation may include estimating and correcting, by the processor, sloping in a PSD floor of the PSD of the first amplified signal to generate a filtered signal comprising a processed PSD. The first signal processing operation may include summing the entire processed PSD to generate a first sum. The first signal processing operation may include comparing the first sum to a threshold. The first signal processing operation may include indicating, by the processor, the presence of the scattered laser light in the detection region in response to the first sum exceeding the threshold and indicating, by the processor, the absence of the scattered laser light in the detection region in response to the first sum not exceeding the threshold.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the following illustrative figures. In the following figures, like reference numbers refer to similar elements and steps throughout the figures.

FIG. 1 illustrates an example detection scenario where laser light is being detected by a detection system, in accordance with various embodiments;

FIG. 2 shows a detailed example of one implementation of a system for laser detection, in accordance with various embodiments;

FIG. 3 which depicts an illustration showing the coherent interference between the signal and local oscillator laser as measured by the BCD receiver, in accordance with various embodiments;

FIG. 4A illustrates a graph of calculated receiver operating characteristic (ROC) curves for detection of 20 dBm laser, in accordance with various embodiments;

FIG. 4B illustrates a graph of ROC plots on logarithmic scale to illustrate a deviation from near unity detection, in accordance with various embodiments;

FIG. 4C illustrates a graph of area under the curve (AUC) for the ROC plots as a function of signal laser power and integration time, in accordance with various embodiments;

FIG. 5A shows a first graph that depicts ROCs for a range of acquisition times for laser detection with a coherent receiver for a 12 dBm laser, in accordance with various embodiments;

FIG. 5B shows a second graph that depicts ROCs for a range of acquisition times for laser detection with a coherent receiver for a 14 dBm laser, in accordance with various embodiments;

FIG. 5C shows a third graph that depicts ROCs for a range of acquisition times for laser detection with a coherent receiver for a 16 dBm laser, in accordance with various embodiments;

FIG. 5D shows a fourth graph that depicts ROCs for a range of acquisition times for laser detection with a coherent receiver for an 18 dBm laser, in accordance with various embodiments;

FIG. 5E shows a second graph that depicts ROCs for a range of acquisition times for laser detection with a coherent receiver for a 20 dBm laser, in accordance with various embodiments;

FIG. 6 shows a system for coherent detection for identification of scattered laser light in a detection region, in accordance with various embodiments;

FIGS. 7-8 show flowcharts of processes performed by the system, in accordance with various embodiments;

FIG. 9 shows an implementation of a local oscillator and/or local oscillator source, in accordance with various embodiments;

FIG. 10 shows an example engineered local oscillator spectrum, in accordance with various embodiments; and

FIG. 11 shows charts illustrating an example system performance where an optical frequency comb is created using a square wave to drive a phase modulator, in accordance with various embodiments.

### DETAILED DESCRIPTION

A system, apparatus and/or method for coherent detection for the identification of scattered laser light in a bright incoherent background by an optical sensor connected to a processor is disclosed herein, and is further described as set forth herein.

This disclosure will demonstrate the detection of laser light, which has been scattered from micron-scale atmospheric particulates, using a balanced heterodyne detection system with a non-cooperative tunable laser as a local oscillator source. The signal generated by the coherent detection receiver is provided to a signal processing algorithm designed to discriminate scattered laser light entering the receiver from incoherent background and internal receiver noise. A receiver operating characteristic quantifies the performance of the receiver and demonstrates that optical coherence can be used as a parameter for laser detection even after the process of optical scattering from a disordered media.

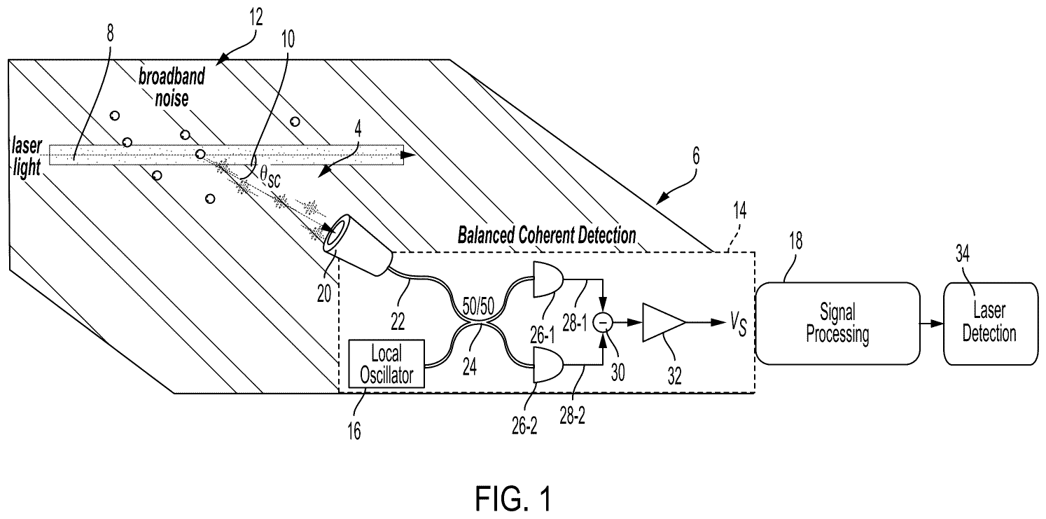

A laser warning receiver (LWR) is a passive optical detection technology that alerts a user when laser light is incident upon the receiver. LWRs have found military applications in the detection of LADAR systems, and civilian application in alerting drivers to the presence of laser radar operated by law enforcement. Typically, these LWR systems employ direct detection (photon counting) methods for the identification of laser light, relying on the assumption that laser signals, operating in a narrow optical band, will be much brighter than the incoherent environmental background into which the field of view of the LWR is looking. While this assumption is likely valid for a laser directly incident on the LWR, a desirable performance feature would be the ability to detect a laser even before it hits the LWR. The sensitivity to detect laser light scattered from the primary beam via Mie scattering processes (as shown in FIG. 1) would enable such a capability, however Mie processes are highly-directional favoring forward scattering. Therefore optical intensities at scattering angles 10 that are large scattering angles (θ_{SC}>10°), and in an environment with natural daylight causes broadband noise 12 that make direct detection of these scattering processes challenging for typical laser powers and sensor standoff distances. More specifically, FIG. 1 illustrates an example detection scenario 2 where laser light 4 is being detected by a detection system 6, where in some instances, the laser light is scattered from a primary beam 8 via Mie scattering. FIG. 1 has a shot-noise limited balanced coherent detection (BCD) receiver to detect the presence of a laser by collecting atmospherically scattered light. Even in the presence of strong broadband background nose, the BCT can discriminate the presence of weakly scattered laser light.

Experiments have demonstrated the detection of atmospherically scattered laser light using direct detection receivers; and, recently, the fundamental quantum limit to discriminating coherent laser light and incoherent noise light was demonstrated. These measurements require ultra-sensitive detectors, narrow-band optical filtering and often operation at nighttime for sufficient noise suppression to perform detection of scattered laser light. Moreover, the requirement for narrowband optical filtering requires that the receiver know, a-priori, the wavelength of the laser for which it is searching, a burdensome demand.

This disclosure presents a system, apparatus, and method, and characterizes performance of the same by developing experimental results that demonstrates coherent heterodyne detection of near infrared laser light scattered off-axis in a broadband daylight background. In an example detection system 6, a balanced coherent receiver 14 is implemented. The receiver 14 uses no optical filtering, and a non-cooperative, tunable laser source for the local oscillator 16 for the coherent detection receiver. The receiver 14 feeds a signal processing device 18 implementing a novel signal processing algorithm. The signal processing algorithm developed for the laser detection system 6 demonstrated nearly perfect detection with zero false alarms for an integration time >40 μs. Coherent detection of atmospherically scattered laser light is usable in Doppler LADAR systems where the same laser that generates the signal light is used to implement the local oscillator to detect the laser light scattered from atmospheric particulates for measurement of wind fields. This mono-static architecture using a single laser guarantees coherence and deterministic wavelength matching between the signal and local oscillator. In this document, the demonstration implements a bi-static architecture, using non-cooperative lasers, and demonstrate that coherent detection can be implemented successfully to detect weak laser light, even after undergoing scattering, and reject incoherent background light.

A diagram illustrating the physical sensing scenario and the design for balanced coherent detection (BCD) is shown in FIG. 1. A laser beam 8 (with frequency f_{S}) propagating through an atmospheric channel interacts with atmospheric aerosols and undergoes a Mie scattering. A small fraction of the laser light is scattered at a scattering angle 10 from the channel and received by an aperture 20 which couples the scattered laser light, along with environmental noise light (broadband noise 12), into a single-mode optical fiber 22 directing the light to a coherent receiver tasked with determining whether or not laser light is present in the channel. The BCD receiver mixes the signal light with a local oscillator 16 laser (with frequency f_{LO}) in a 50:50 beamsplitter 24 and the resulting mixture is directed to two photodetectors (first photodetector 26-1 and second photodetector 26-2) with matched responsivities which generate photocurrents (first photocurrent 28-1 and second photocurrent 28-1) proportional to the optical power detected. These two photocurrents 28-1, 28-2 are then subtracted from each other by a subtractor 30 and the resultant current is sent to an amplifier 32 with transimpedance gain G_{T}, resulting in an output voltage V_{S}=G (I₁−I₂).

The coherence time of the broadband environmental noise light is vanishingly small and therefore there is no coherent interference with the narrowband local oscillator laser in the receiver on timescales relevant to electrical bandwidths, resulting in V_{S}=0 at the output of the receiver. Received laser light, however, does generate coherent interference under the assumption that the optical bandwidth of the laser is narrow (within the electrical bandwidths of the BCD) and the wavelength is near the wavelength of the local oscillator (both within the electrical bandwidth of the BCD receiver). The concept for balanced coherent detection (BCD) may be introduced as a method to reject excess intensity noise in the local oscillator laser. The amplified current is ingested by a signal processor 18 which then indicates that a laser is or is not detected (laser detection 34).

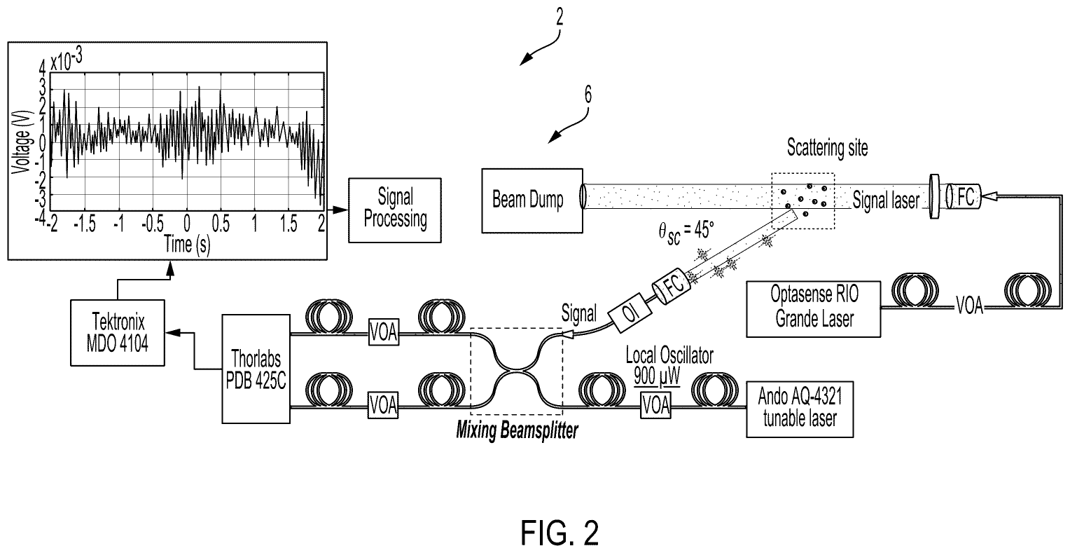

FIG. 2 shows a detailed example of one implementation of this system 6 in an example detection scenario 2 performed as an experiment to qualify the design. In the experimental setup, the signal laser is attenuated with a mechanical variable optical attenuator (VOA) coupled to free-space with a fiber collimator (FC). The signal laser is directed through a glass cell containing dust particles at the scattering site. Scattered laser light is collected by the receiver, coupled into fiber and directed through an optical isolator (OI) to the BCD receiver.

More specifically, FIG. 2 shows RIO Grande amplified, fixed frequency, continuous wave (CW) laser with wavelength λ_{S}=1549.646 nm that serves as the signal laser. This laser is capable of generating 200 mW of laser light and reports kHz-scale linewidths. A mechanical variable optical attenuator (VOA) is used to control the intensity of the signal laser. The signal laser was coupled to free-space through a fiber collimator (Thorlabs F220 APC-1550) and a half-wave plate (HWP) was used to rotate the linear polarization of the light. The signal laser is then directed through a glass cell containing environmental particulates collected from both indoor and outdoor settings which simulates an atmospheric signal path. The sample contains a mixture of environmental dust and pollen. The particulates in the jar were agitated by a motor such that it was approximated to be evenly distributed throughout the cell as the laser passed through the cell. The cell was positioned such that the beam passed directly through the center of the cell minimizing scattering due to interaction with the glass cell walls. A fiber collimator (also Thorlabs F220 APC-1550) is placed at an angle θ_{SC}=45° relative to the signal laser propagation direction to collect signal laser light scattered from the particles in the cell. This fiber collimator couples free-space light with a mode field diameter of 2 mm into a single-mode optical fiber with 9 μm core. Laser light scattered from the dust particles in the cell, as well as background light, is collected by the fiber collimator and coupled to a single-mode optical fiber and directed into the signal input to the balanced coherent detection system. An optical isolator (Thorlabs IO-H-1550FC) is inserted into the setup to prevent the local oscillator from leaking through the receiver optical setup and into the free-space channel. The balanced coherent detection receiver is operated with a tunable laser source (Ando AQ-4321) with a tuning range λ_{LO}=1520 1600 nm, a tuning resolution of 1 pm and reports 200 kHz linewidth. The local oscillator laser power was 900 μW ensuring that the BCD receiver operated at the shot-noise limit.

The collected signal light is mixed with the local oscillator laser in a 50:50 fiber beamsplitter and the two outputs of the beamsplitter are passed through VOAs and into an amplified balanced detector (Thorlabs PDB 425C), the output of which was captured by an oscilloscope operating as the data acquisition system. The VOAs connecting the mixing beamsplitter to the balanced detector are used to match the path loss between the arms, as any small path loss difference will result in an amplified error signal at the output of the balanced detector. Alignment between the signal and receiver spatial modes is established using a single laser as both the signal and local oscillator, with the signal and receiver trained on a fixed scatterer to observe a homodyne signal when the scattered light was successfully coupled to the receiver. Once this alignment is established, the local oscillator input is replaced with the tunable laser source. The tunable laser wavelength is scanned to search for frequency alignment with the signal laser wavelength observing the beating signature in the BCD.

The receiver collects light scattered by particles that are within the intersectional volume (V_{INT}) defined by the overlap between the spatial mode of the signal laser and the spatial mode of the receiver collimator. This intersectional volume is calculated to be V_{INT}˜9*10⁻³ milliliters. The range from this intersection location to the receiver was approximately 50 cm, limited by the geometry of the optical table used for the experimental qualification. While the particle size distribution in the sample was not specifically measured, careful studies show that aerosols of this type (mixture of pollen and dust) have a mean diameter 10 μm and mass distribution of 10-100 nanograms/grain. One may estimate the average number of particles in V_{INT} by weighing the sample (800 mg) and dividing by the referenced particle mass (50 ng/grain), to be 150 particles.

Typical values for dust concentration in the atmosphere are between 1-10 μg/m³. This may be substantially lower than the concentrations used for the experiment. For the experiment, high concentrations were chosen due to the limited acquisition time of the experiment to ensure that there would be scatterers in the intersectional volume while data acquisition was being performed. Signal traces were collected, having about 20 million data points sampled at 250 MHz, with a total length of 80 ms. Data was collected for a variety of signal laser powers ranging from 7 dBm-20 dBm. While one may not directly verify the scattered laser power collected, one may perform simulations of the Mie scattering process using the MiePlot program and estimate that the experiment collected ˜2-40 pW of scattered laser light over this range of signal laser intensity.

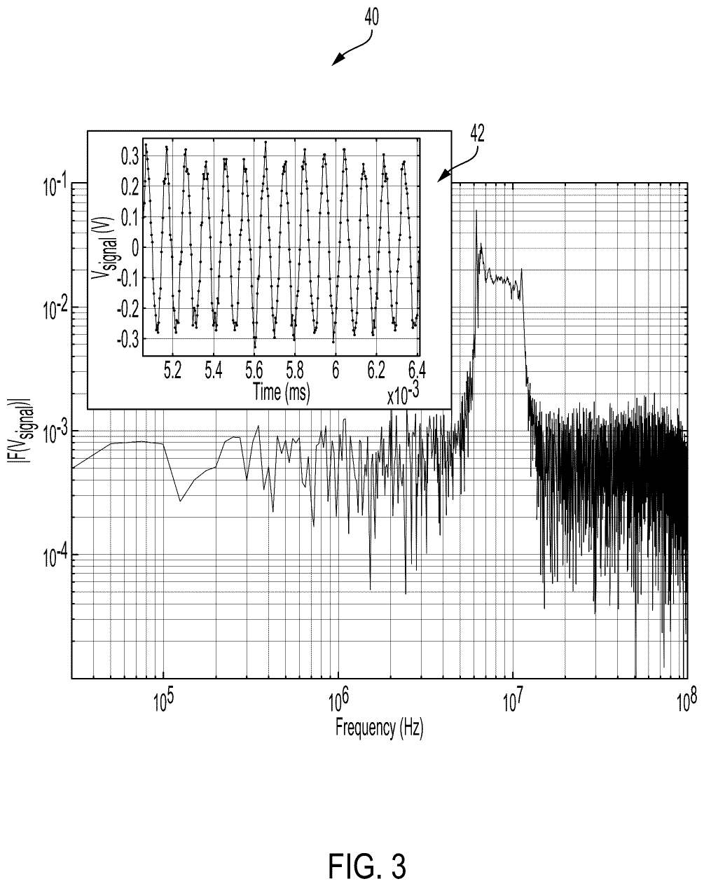

The experiment also collected data with the signal laser extinguished so that measurements can be generated for both probability of detection (P_{D}) and probability of false alarm (P_{FA}) for the BCD receiver to detect laser light. An example data capture from the oscilloscope is shown in FIG. 3 which depicts an illustration 40 showing the coherent interference between the signal and local oscillator laser as measured by the BCD receiver. The two lasers are separated in optical frequency by 8 MHz, but over the duration of data capture (40 ms) the power spectral density shows that the frequencies of the two lasers drift relative to one another by 5 MHz. More specifically, FIG. 3 shows the Fourier transform of a 40 ms capture of the signal and local oscillator mixing in the balanced coherent detection receiver. For this illustrative data, both lasers were delivered to the balanced coherent detection system via fiber. The data illustrates the frequencies of the laser drifting relative to one another over a range of 5 MHz during this time period. A small (about 1 microsecond) section of the time-dependent signal at the output of the balanced coherent detection receiver is shown in the insert 42.

As an independent test of the capability of the BCD to reject incoherent background light was coupled from an incandescent bulb (Thorlabs QTH10) with high intensity in the wavelength band of interest (0.5 pW) into the receiver while detecting a laser signal of 25 fW. There was no measurable degradation in the output signal (V_{S}) from the BCD receiver, as it is insensitive to incoherent light.

The experiment analyzed raw signal data collected by the oscilloscope from the BCD receiver to identify characteristics of the signal that can be used to determine if an active laser were in the field-of-view of the coherent receiver. When analyzing signals in the frequency domain, it was observed that data obtained when the laser was active consistently exhibited peaks in the power spectral density (PSD) in the >10 MHz range. With sufficient acquisition time, these peaks are consistently 1 dB above the PSD floor and the experiment uses this feature of the measured signal as a sufficient statistic for laser detection.

To process the raw data from the BCD receiver, the system accounted for several features in the signal and noise floor. There was a divergence in the PSD at frequencies <1 MHz owing to excess noise in the local oscillator laser. Also, the electrical bandwidth of the balanced detector is 75 MHz and the oscilloscope has an internal low pass filter of 250 MHz, so the magnitude of the PSD rolls off at frequencies >100 MHz. Finally, the center frequency, spectral width and spectral shape of the signal peaks is random providing little a-priori information for automated peak detection. The signal processing procedure implemented (1) high-pass filtering of the signal with a cutoff of 1 MHZ, (2) calibrating the spectral features at higher frequencies (>100 MHz) and (3) integrating the result to generate the variable ( [symbol] ) used as the decision variable to determine if a laser is present.

The system processed data collected with signal laser power ranging between 7 dBm and 20 dBm. At each power setting, the system collected 80 ms data burst at a 250 MHz sampling rate. To simulate shorter acquisition times, segments were extracted from the measurements corresponding to acquisition time ranging from 4 microseconds to 40 microseconds. For each simulated acquisition time, there were extracted as many independent segments (e.g., no overlap between samples) as possible from the 80 ms acquisition. Dividing the data in this way enables one to generate 200 to 20,000 independent samples for each laser power setting, depending on the simulated acquisition time. Additionally, the system extracted segments of the same time lengths from a signal collected when there was no active laser present. All segments were processed using the signal processing chain described herein, and output of the chain was used to generate receiver operating characteristic (ROC) curves to enable study of coherent receiver performance at different laser power settings and acquisition times.

The ROC curve plots the probability of successful detection of a laser (Pp) against the false-alarm probability (P_{FA}) for indicating a laser detection when no laser is present. To generate the ROC one may pick a threshold value ( [symbol] _{TH}) for the integral of the PSD and for a given signal laser power, and acquisition time if [symbol] > [symbol] _{TH} the system determines that a laser is present, and if [symbol] < [symbol] _{TH} the system determines no laser was present. The detection probability is computed as P_{D}=P( [symbol] > [symbol] _{TH}|laser) and the false alarm probability is computed as P_{FA}=P ( [symbol] > [symbol] _{TH}|no laser). The system repeated this process for each of the acquisitions for a given signal laser power, and swept the value [symbol] < [symbol] _{TH}<∞ to generate the ROC curves.

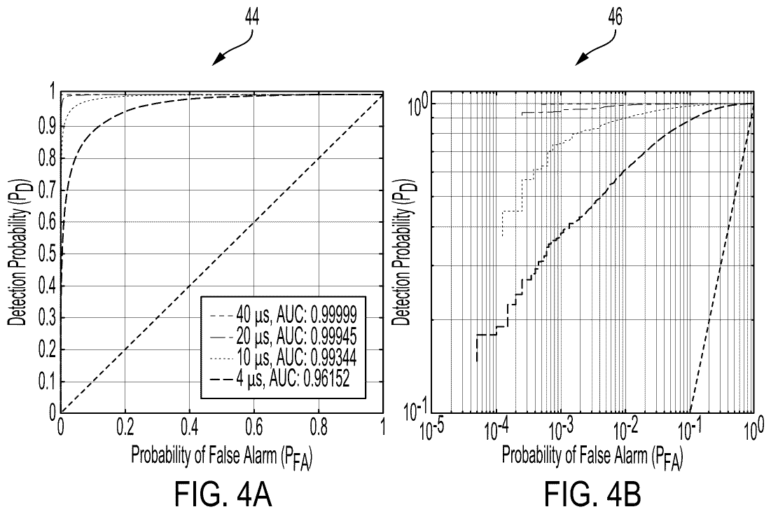

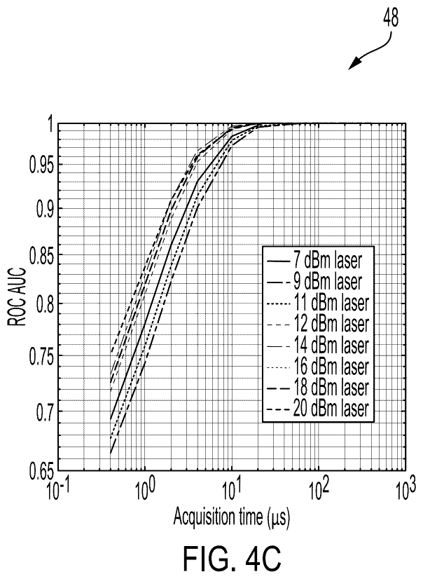

Sample detection results are shown in FIGS. 4A, 4B, and 4C. These figures show ROCs plotted for data collected with the coherent receiver with a 20 dBm laser active as simulated acquisition time varies. FIG. 4A illustrates a graph 44 of calculated receiver operating characteristic (ROC) curves for detection of 20 dBm laser with acquisition time ranging from 4 microseconds to 40 microseconds. The black dashed line sets the threshold for zero detection sensitivity. FIG. 4B illustrates a graph 46 of ROC plots on logarithmic scale to illustrate the deviation from near unity detection. The legend is shared with FIG. 4A. FIG. 4C illustrates a graph 48 of area under the curve (AUC) for the ROC plots as a function of signal laser power and integration time.

Detection accuracy increases as acquisition time increases. In fact, as long as acquisition time was greater than 20 microseconds, the system achieved 99% detection accuracy or greater with at most with 1% false positive rate. Furthermore, at acquisition time of 100 microseconds or greater, the system was able to completely distinguish all simulated acquisitions collected with the laser active from acquisitions when there was no laser present. Similar detection results were seen at all laser powers that that were experimented with. In fact, at 100 microseconds acquisition time or greater, it was possible to determine whether or not the laser was active with all measurements taken during the experiments. Detection performance of the coherent receiver from all measurements across all powers and simulated acquisition times are summarized in FIGS. 4A-C. This plot shows the area under the curve (AUC) calculated by integrating the ROCs generated from processed data for each laser power at each simulated acquisition time. Laser detection improved at shorter acquisition times as the power of the laser increases. This is shown through the fact that AUC increases at lower acquisition times when laser power is higher. This may be due to the fact that more scatter passes through the receiver's FOV as laser power increases, resulting in a stronger measured signal. At 1 microseconds acquisition time or longer, calculated AUC is >0.95.

The work presented here demonstrates that BCD can be used for the detection of laser light by detecting weakly scattered light from atmospheric particulates, such as dust. While the demonstration was performed in a laboratory, the intensity of the scattered laser light detected (<50 pW) is similar to that measured in large-scale scattering experiments conducted in marine environments, where there are measured radiance values of 1 nW/m² received per Watt of source laser power for a 45° scattering angle, as was configured in the experiment.

The BCD receiver constitutes an important capability in LWR technology as it rejects strong incoherent background noise light while simultaneously having sensitivity over a broad wavelength range given a tunable local oscillator. The results presented demonstrate detectability of a scattered laser signal within a 100 MHz optical bandwidth (0.8 pm), defined by the electrical bandwidth of the balanced detector. As the system demonstrated excellent detectability in acquisition time <20 microseconds over this bandwidth, one can expect that with a tunable local oscillator laser scanning over a wavelength range of 10 nm (comprised of approximately 1.25*10⁴ of these frequencies would require <250 ms.

In this work, the detection algorithm employed a signal processing chain. The signal processing may be custom designed. In other instances, the signal processing may be a data-driven anomaly detection algorithm. Additionally, the signal processing capabilities can be easily enhanced to extract parameters of the signal laser, such as wavelength, linewidth and frequency stability, which direct detection solutions cannot provide.

Thus one may appreciate that various innovative aspects may be present. For instance, the system may be described as having a sensor for detecting the presence of weak laser light in an environment with bright incoherent light background. The system may be described as using balanced coherent detection (homodyne and/or heterodyne detection) for the detection of scattered laser light where the laser light has been scattered from media such as a Lambertian surface, atmospheric particulates, or other disordered media. A signal processing chain is provided that takes raw signal from a coherent detection (heterodyne and/or homodyne) system and determines if there is laser light present at the input of the receiver. A hybrid system may use both direct detection and balanced coherent detection for the identification and geo-location of laser light. A coherent receiver for laser detection may be provided that can be scanned to increase the spatial field of view for laser detection. A coherent receiver may be provided for laser detection that can be made into an array to increase the spatial field of view for laser detection.

Directing attention now to specific features of the signal processing 18 apparatus (FIG. 1), a signal processing chain may have a variety of aspects. For instance, the signal processing may include applying a high pass filter to raw signals. For instance, a high pass filter may have a cutoff of about 1 MHz to remove lower frequency components in the signal that cause a spike in PSD regardless of whether there is an active laser. The signal processing may include calculating a PSD of the filtered signal. The signal processing may include estimating and correcting for sloping in the PSD floor. For instance, a system may currently perform a rolling average of measured PSD and then subtracting PSD by the rolling average. However, this may also be performed by calibration measurements from separate signal(s) when it is known that the laser is not present to obtain a measurement of a floor instead of estimating the floor from collected data. The signal processing may include finding a location of maximum value of a final processed signal and may include summing around a peak with a fixed window size.

In some instances, it was determined that performance can be improved by replacing estimating and correction for sloping in the PSD floor with a calibration step where one used a measurement taken when it is known that there is no active laser to correct for PSD floor sloping.

In a further example, a signal processing 18 apparatus may have different or additional aspects. For instance, the signal processing may include applying a high pass filter to raw signals. A high pass filter may have a cutoff of about 1 MHz to remove lower frequency components in the signal that cause a spike in PSD regardless of whether there is an active laser. The signal processing may include calculating a PSD of the filtered signal. The signal processing may include estimating and correcting for sloping in the PSD floor. For instance, the system may subtract a calculated PSD from a newly measured signal by calculating a PSD of previously collected processed background signal(s). The signal processing may then include summing an entire processed PSD. In this implementation, it was determined that when processing data with a calibration measurement, the system can remove the peak detection step and simply sum the entire PSD. This enables the system to potentially capture multiple peaks while also reducing processing time because the system no longer needs to search for peaks in a signal before summing.

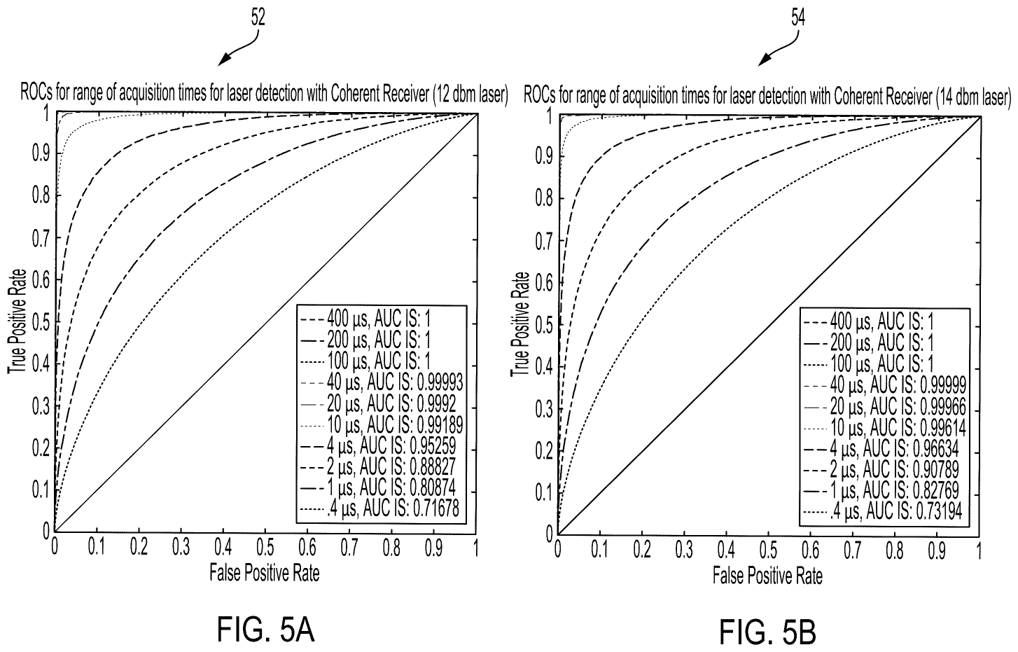

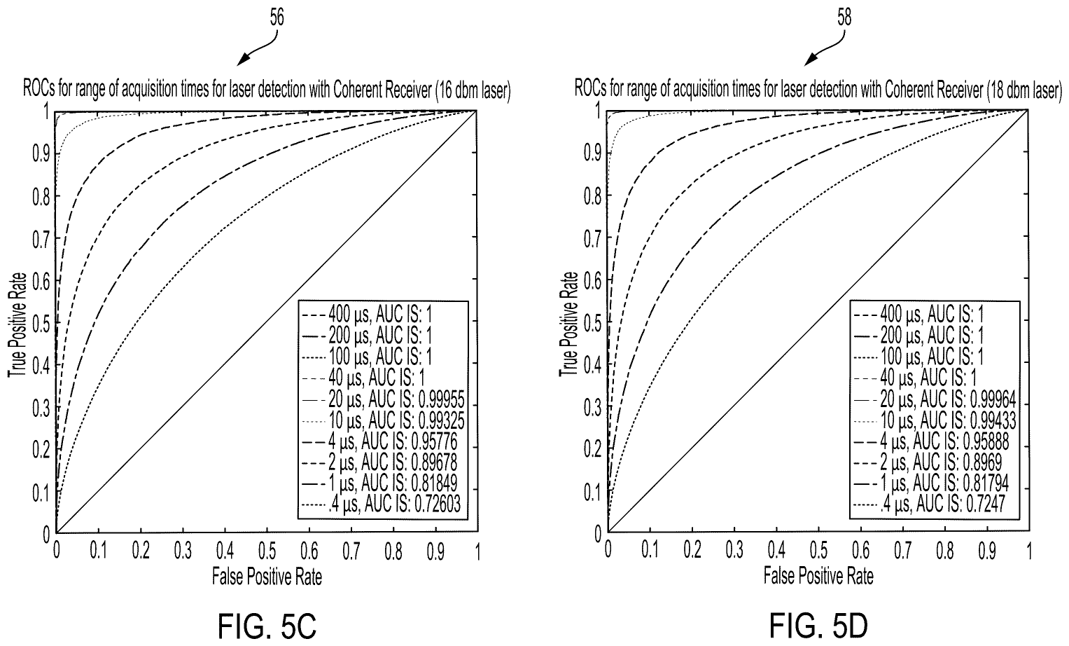

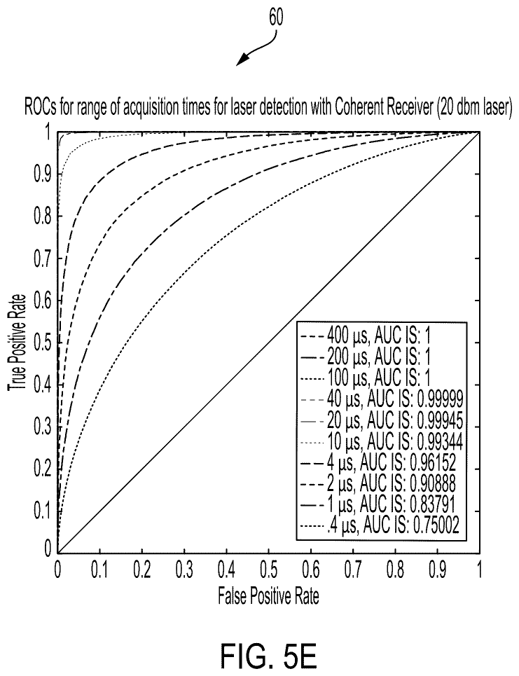

Turning now to FIGS. 5A-5E, a collection of graphs is shown including a first graph 52, second graph 54, third graph 56, fourth graph 58, and fifth graph 60. FIG. 5A shows a first graph 52 that depicts ROCs for a range of acquisition times for laser detection with a coherent receiver for a 12 dBm laser. FIG. 5B shows a second graph 54 that depicts ROCs for a range of acquisition times for laser detection with a coherent receiver for a 14 dBm laser. FIG. 5C shows a third graph 56 that depicts ROCs for a range of acquisition times for laser detection with a coherent receiver for a 16 dBm laser. FIG. 5D shows a fourth graph 58 that depicts ROCs for a range of acquisition times for laser detection with a coherent receiver for an 18 dBm laser. FIG. 5E shows a fifth graph 60 that depicts ROCs for a range of acquisition times for laser detection with a coherent receiver for a 20 dBm laser. Referring to all of FIGS. 5A-5E, to evaluate the processing chain, data was processed using the coherent receiver using data collected with laser power between 12 dBm and 20 dBm, in 2 dBm increments, as mentioned. Data was initially collected in 0.08 s with a 250 MHz sampling rate. To simulate acquisition at shorter acquisition times, segments of this signal were extracted with acquisition time ranging from 0.4 microseconds to 400 microseconds. For each simulated acquisition time, one may extract as many independent segments, with no overlap between samples, as possible from the larger signal. For instance, a number of independent samples may, in various instances, range between 200 and 20,000. Segments were similarly extracted from a signal measured without an active laser. Segments were processed using the baseline signal processing chain mentioned previously, to generate ROC curves at different simulated acquisition times.

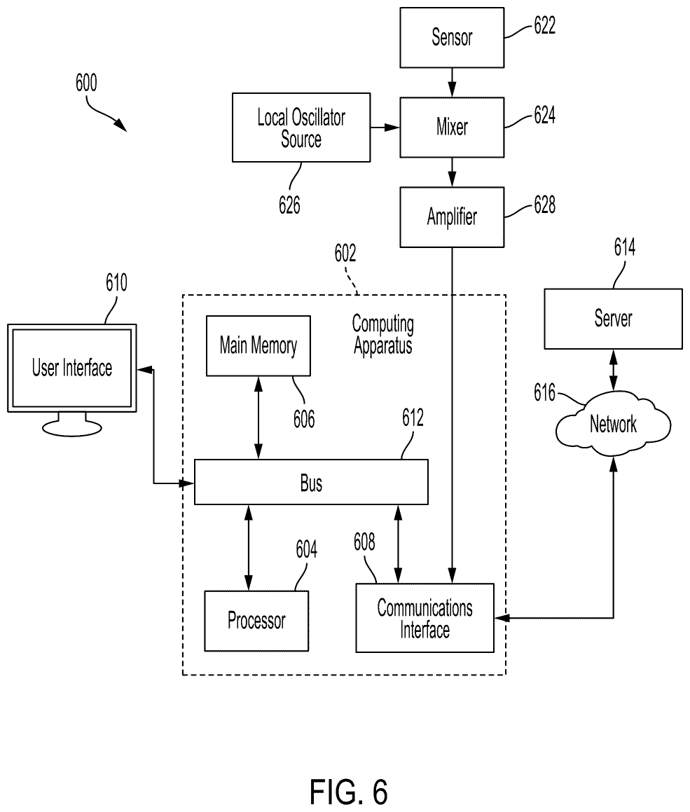

Having introduced the operative principles of an example system, attention is now directed to FIG. 6 for a further example of a practical system. FIG. 6 shows a system 600 for coherent detection for identification of scattered laser light in a detection region. The system 600 (e.g., a computing system) may include a computing apparatus 602. The computing apparatus 602 may include one or more processors 604, a memory 606 and/or a bus 612 and/or other mechanisms for communicating between the one or more processors 604. The system 600 may be a cloud computing system including processors, servers, storage, databases, networking, software, analytics, and/or intelligence accessed or performed over or using the Internet (“the cloud”). The one or more processors 604 may be implemented as a single processor or as multiple processors. The one or more processors 604 may execute instructions stored in the memory 606 to implement the applications and/or detection of the system 600.

The one or more processors 604 may be coupled to the memory 606. The memory 606 may include one or more of a Random Access Memory (RAM) or other volatile or non-volatile memory. The memory 606 may be a non-transitory memory or a data storage device, such as a hard disk drive, a solid-state disk drive, a hybrid disk drive, or other appropriate data storage, and may further store machine-readable instructions, which may be loaded and executed by the one or more processors 604.

The memory 606 may include one or more of random-access memory (“RAM”), static memory, cache, flash memory and any other suitable type of storage device or computer readable storage medium, which is used for storing instructions to be executed by the one or more processors 104. The storage device or the computer readable storage medium may be a read only memory (“ROM”), flash memory, and/or memory card, which may be coupled to a bus 612 or other communication mechanism. The storage device may be a mass storage device, such as a magnetic disk, optical disk, and/or flash disk that may be directly or indirectly, temporarily, or semi-permanently coupled to the bus 612 or other communication mechanism and be electrically coupled to some or all the other components within the system 600 including the memory 606, the user interface 610 and/or the communications interface 608 via the bus 612.

The term “computer-readable medium” is used to define any medium that can store and provide instructions and other data to a processor, particularly where the instructions are to be executed by a processor and/or other peripheral of the processing system. Such medium can include non-volatile storage, volatile storage, and transmission media. Non-volatile storage may be embodied on media such as optical or magnetic disks. Storage may be provided locally and in physical proximity to a processor or remotely, typically by use of network connection. Non-volatile storage may be removable from computing system, as in storage or memory cards or sticks that can be easily connected or disconnected from a computer using a standard interface.

The system 600 may include a user interface 610. The user interface 610 may include an input/output device. The input/output device may receive user input, such as a user interface element, hand-held controller that provides tactile/proprioceptive feedback, a button, a dial, a microphone, a keyboard, or a touch screen, and/or provides output, such as a display, a speaker, an audio and/or visual indicator, or a refreshable braille display. The display may be a computer display, a tablet display, a mobile phone display, an augmented reality display or a virtual reality headset. The display may output or provide a data related to identification of scatter laser light in a detection region.

The user interface 610 may include an input/output device that receives user input, such as a user interface element, a button, a dial, a microphone, a keyboard, or a touch screen, and/or provides output, such as a display, a speaker, headphones, an audio and/or visual indicator, a device that provides tactile/proprioceptive feedback or a refreshable braille display. The speaker may be used to output audio associated with the audio conference and/or the video conference. The user interface 610 may receive user input that may include configuration settings for one or more user preferences, such as a selection of joining an audio conference or a video conference when both options are available, for example.

The system 600 may have a network 616 connected to a server 614. The network 616 may be a local area network (LAN), a wide area network (WAN), a cellular network, the Internet, or combination thereof, that connects, couples and/or otherwise communicates between the various components of the system 600 with the server 614. The server 614 may be a remote computing device or system that includes a memory, a processor and/or a network access device coupled together via a bus. The server 614 may be a computer in a network that is used to provide services, such as accessing files or sharing peripherals, to other computers in the network.

The system 600 may include a communications interface 608, such as a network access device. The communications interface 608 may include a communication port or channel, such as one or more of a Dedicated Short-Range Communication (DSRC) unit, a Wi-Fi unit, a Bluetooth® unit, a radio frequency identification (RFID) tag or reader, or a cellular network unit for accessing a cellular network (such as 3G, 4G or 5G). The communication interface may transmit data to and receive data from the different components.

The server 614 may include a database. A database is any collection of pieces of information that is organized for search and retrieval, such as by a computer, and the database may be organized in tables, schemas, queries, reports, or any other data structures. A database may use any number of database management systems. The information may include real-time information, periodically updated information, or user-inputted information.

In various embodiments, the system 600 further comprises a sensor 622 (e.g., an optical sensor), a mixer 624, a local oscillator source 626, and an amplifier 628. In various embodiments, the processor 604 is electronically coupled to the processor 604 (e.g., through the communications interface 608). Although illustrated as being electrically coupled to the processor 604 of the system 600 through communications interface 608, the present disclosure is not limited in this regard. For example, the amplifier can be electronically coupled to the processor 604 through the bus 612 and still be within the scope of this disclosure. In various embodiments, the sensor 622 is adaptable to detect weak laser light, even in the presence of high noise light.

In various embodiments, an aperture of the sensor 622 is configured to collect a raw optical signal. In various embodiments, the mixer 624 is connected (e.g., wired or wirelessly) to the sensor 622. In this regard, the mixer can be configured to mix the raw optical signal with a carrier signal generated by the local oscillator source 626 to generate a mixed baseband signal, in accordance with various embodiments. In various embodiments, the amplifier 628 is connected (e.g., wired or wirelessly) to the mixer to amplify the mixed baseband signal and output a first amplified signal. In various embodiments, the system 600 utilizes a balanced coherent detection. A “balanced coherent detection” as referred to herein includes implementing the mixer 624 with an optical beam splitter, and implementing the amplifier 628 with a balanced photodiode. In various embodiments, by implementing the amplifier 628 and the mixer 624 with the balanced coherent detection, the system 600 can naturally reject the background noise such as ambient light, which has been a limiting factor in many optical sensors. In various embodiments, the processor 604 is connected to the amplifier 628 as described previously herein and configured to receive the first amplified signal and to perform a first signal processing operation to detect a presence or an absence of the scattered laser light in the detection region. One may appreciate that components illustrated in FIG. 6 correspond to similar components illustrated in FIG. 1 and/or FIG. 2.

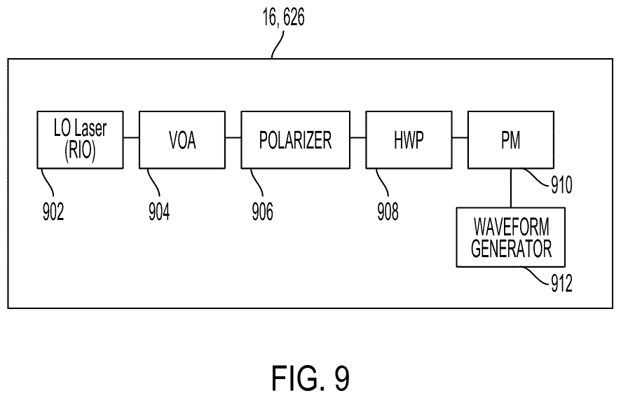

In various embodiments, the local oscillator source 626 can comprise a non-cooperative tunable laser, an optical frequency comb with an engineered spectrum, a continuous wave laser with a time-modulated amplitude and phase, or the like. The present disclosure is not limited in this regard. Various features of an example local oscillator source 626 will be discussed further herein, especially in reference to FIG. 9 in various following paragraphs.

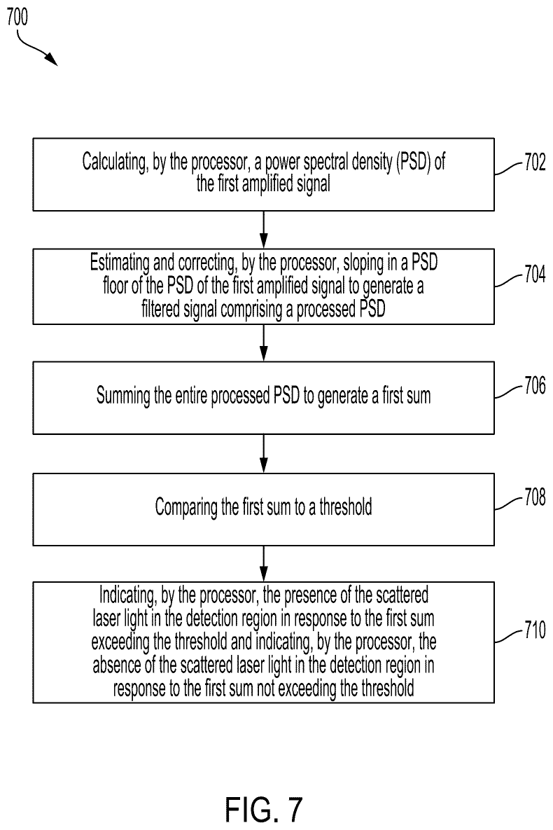

Referring now to FIG. 7, a process 700 performed by system 600 (e.g., by the processor 604) is illustrated, in accordance with various embodiments. With combined reference now to FIGS. 6 and 7, the process 700 can comprise calculating, by the processor 604, a power spectral density (PSD) of the first amplified signal (block 702). The process 700 can further comprise estimating and correcting, by the processor 604, sloping in a PSD floor of the PSD of the first amplified signal to generate a filtered signal comprising a processed PSD (block 704). The process 700 can further comprise summing the entire processed PSD to generate a first sum (block 706) and comparing the first sum to a threshold (block 708). In various embodiments, the process 700 can further comprise indicating, by the processor 604, the presence of the scattered laser light in the detection region in response to the first sum exceeding the threshold and indicating, by the processor, the absence of the scattered laser light in the detection region in response to the first sum not exceeding the threshold (block 710).

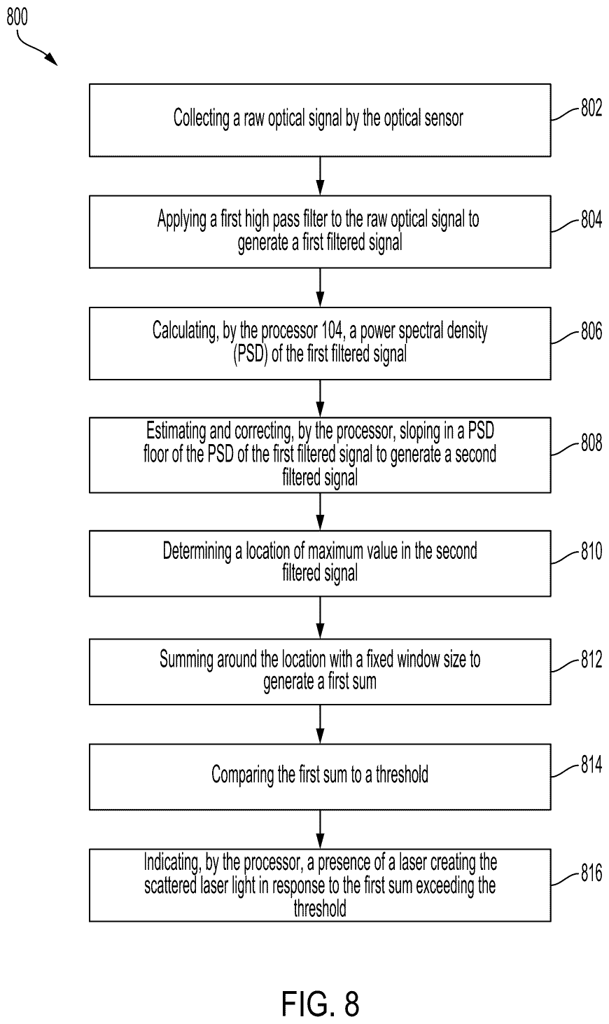

Referring now to FIG. 8, a process 800 performed that can be performed by the system 600 from FIG. 6 (e.g., by the processor 604) is illustrated, in accordance with various embodiments. With combined reference to FIGS. 6 and 8, the process 800 can comprise collecting a raw optical signal by the sensor 622 (e.g., an optical sensor) (block 802). The process 800 can further comprise applying a first high pass filter to the raw optical signal to generate a first filtered signal (block 804). The process 800 can further comprise calculating, by the processor 604, a power spectral density (PSD) of the first filtered signal (block 806). The process 800 can further comprise estimating and correcting, by the processor 604, sloping in a PSD floor of the PSD of the first filtered signal to generate a second filtered signal (block 808). The process 800 can further comprise determining a location of maximum value in the second filtered signal (block 810). The process 800 can further comprise summing around the location with a fixed window size to generate a first sum (block 812). The process 800 can further comprise comparing the first sum to a threshold (block 814) and indicating, by the processor 604, a presence of a laser creating the scattered laser light in response to the first sum exceeding the threshold (block 816).

The previous discussion may further be developed by implementing a variety of local oscillators. FIG. 1 shows a local oscillator 16 and FIG. 6 shows an analogous local oscillator source 626. In each instance, the local oscillator may be a continuous wave laser source. However, the local oscillator 16 and/or local oscillator source 626 may have different configurations. In instances where the local oscillator is a continuous wave laser source, this selection for the local oscillator may limit the instantaneous optical bandwidth sensitivity of the sensor. However, there may be advantages to designing and implementing different local oscillator laser times, where the laser is not CW, but instead has an optical amplitude and phase that is modulated to achieve engineered spectra that can be used for task-specific sensing objectives. For instance, such objectives may include broadening the optical spectrum that the sensor can detect and extracting further information from the signal such as whether or not it is carrying data.

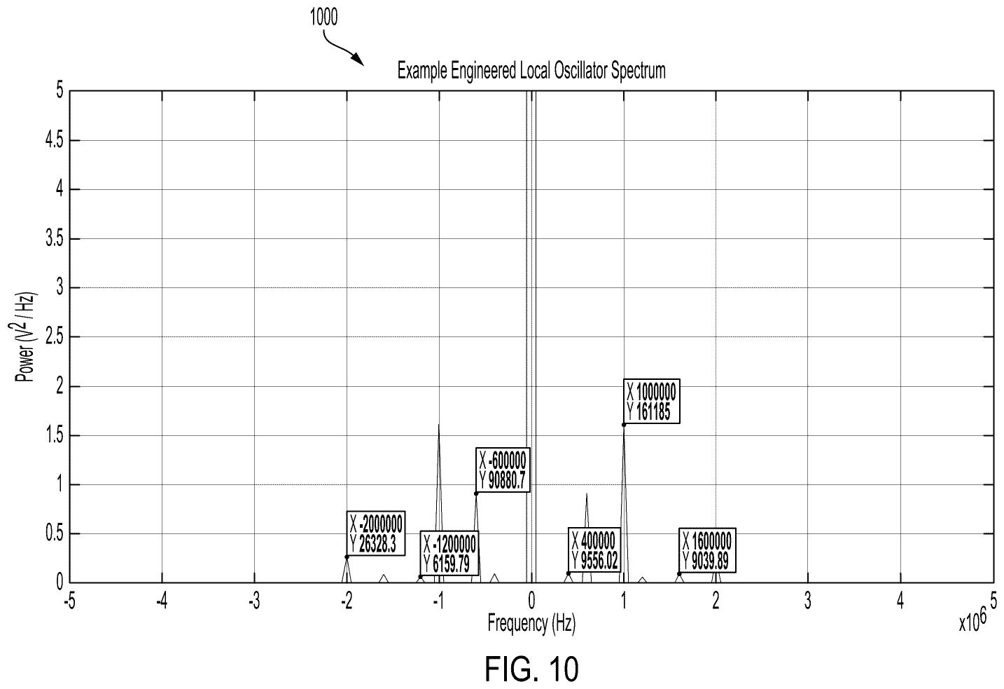

FIG. 9 shows an implementation of a local oscillator 16 and/or local oscillator source 626. A CW laser (RIO) 902 generates a laser beam that is sent to a phase modulator 910 (PM). In various embodiments, the signal chain between the CW laser 902 and the phase modulator 910 has other components to facilitate controlling of an engineered spectra. For instance, a variable optical attenuator (VOA) 904 may be used to control the intensity of the laser beam. A polarizer 906 may be used to control the polarization of the laser beam. A half-wave plate (HWP) 908 may be used to control rotation of the linear polarization of the light. The collection of elements may be arranged so that the laser beam passes through the VOA 904, then the polarizer 906, then the HWP 908, and then to the phase modulator 910. A waveform generator 912 may be connected to the phase modulator 910 to facilitate modulation. Such a local oscillator 16 may be implemented in FIG. 1 with a P_{S}=0.5 microwatts and P_{LO}=500 microwatts. FIG. 10 shows an example engineered local oscillator spectrum 1000 associated with an example embodiment of a FIG. 9 local oscillator 16 and/or local oscillator source 626. By applying custom phase modulation to the CW local oscillator field, one can generate a custom spectrum with an array of harmonics available for mixing with the incoming signal field.

The PM 910 is driven by an electronic waveform generator 912 to engineer the spectrum of the local oscillator 902. By changing the electronics signal generated by the waveform generator one can customize the spectral shape of the local oscillator. There are many ways to create a customized local oscillator including using an optical frequency comb (OFC).

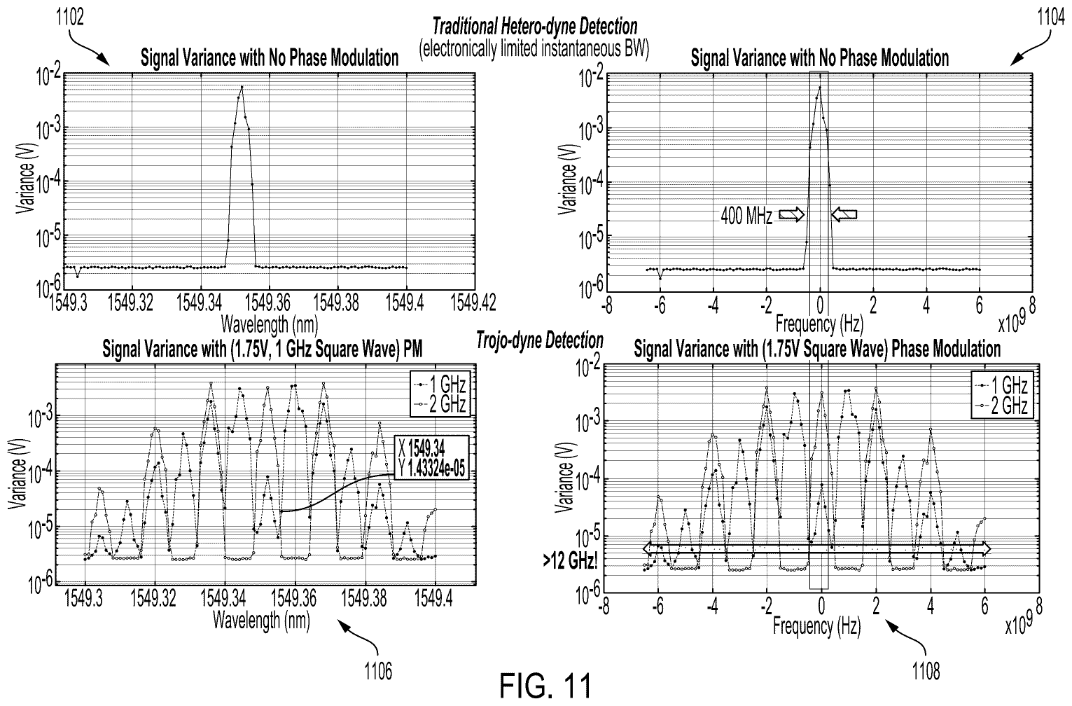

FIG. 11 show an example implementation. As an example implementation, the local oscillator spectrum was engineered to radically expand the instantaneous optical bandwidth over which receiver is sensitive. FIG. 11 shows an example where an optical frequency comb was created using a square wave to drive the PM 908 (FIG. 9). A first graph 1102 and second graph 1104 shows signal variance with no phase modulation for a traditional heterodyne coherent detection of 400 MHz to illustrate the sensitivity bandwidth. A third graph 1106 and fourth graph 1108 show that using the new engineered local oscillator expanded the instantaneous optical bandwidth to >12 GHz, resulting in a 30× improvement instantaneous optical bandwidth.

Having introduced various embodiments of the system, a few example implementations are now instructive. For instance, in an implementation of the method, a method may be provided for coherent detection for identification of scattered laser light by an optical sensor connected to a processor. The method may include collecting a raw optical signal by the optical sensor. The method may include applying a first high pass filter to the raw optical signal to generate a first filtered signal. The method may include calculating, by the processor, a power spectral density (PSD) of the first filtered signal. The method may include estimating and correcting, by the processor, sloping in a PSD floor of the PSD of the first filtered signal to generate a second filtered signal. The method may include determining a location of maximum value in the second filtered signal. The method may include summing around the location with a fixed window size to generate a first sum. The method may include comparing the first sum to a threshold. The method may include indicating, by the processor, a presence of a laser creating the scattered laser light in response to the first sum exceeding the threshold.

The method may have one or more additional aspect. The system that implements the method may have one or more additional aspect. For instance, in various embodiments, the first high pass filter has a cut-off of about 1 MHz. The first high pass filter may have a cut-off selected to remove lower frequency components that cause an unwanted spike in PSD in an absence of the laser. The first high pass filter may be a hardware-based filter. The first high pass filter may be a software-based filter implemented by the processor. The first high pass filter may be at least one of (a) a hardware-based filter and/or (b) a software-based filter implemented by the processor. The estimating and correcting may include taking a rolling average of measured PSD and subtracting PSD by the rolling average. The estimating and correcting may include using a calibration measurement from a separate signal known to omit scattered laser light to determine the PSD floor.

A further implementation of the method may be contemplated. For instance, a method may be provided for coherent detection for identification of scattered laser light by an optical sensor connected to a processor. The method may include collecting a raw optical signal by the optical sensor. The method may include applying a first high pass filter to the raw optical signal to generate a first filtered signal. The method may include calculating, by the processor a power spectral density (PSD) of the first filtered signal. The method may include estimating and correcting, by the processor, sloping in a PSD floor of the PSD of the first filtered signal to generate a second filtered signal comprising a processed PSD. The method may include summing the entire processed PSD to generate a first sum. The method may include comparing the first sum to a threshold. The method may include indicating, by the processor, a presence of a laser creating the scattered laser light in response to the first sum exceeding the threshold.

The method may have one or more additional aspect. The system that implements the method may have one or more additional aspect. For instance, in various embodiments, the first high pass filter has a cut-off of about 1 MHz. In various embodiments, the first high pass filter has a cut-off selected to remove lower frequency components that cause an unwanted spike in PSD in an absence of an active laser. The first high pass filter may be a hardware-based filter. The first high pass filter may be a software-based filter implemented by the processor. The first high pass filter may be at least one of (a) a hardware-based filter and/or (b) a software-based filter implemented by the processor. The estimating and correcting may include taking a rolling average of measured PSD and subtracting PSD by the rolling average. The estimating and correcting may include using a calibration measurement from a separate signal known to omit scattered laser light to determine the PSD floor.

An implementation of a system may be provided. The implemented system may be for coherent detection for identification of scattered laser light in a detection region. The system may include an optical sensor to collect a raw optical signal. The system may include a mixer connected to the optical sensor to mix the raw optical signal with a carrier signal generated by a local oscillator source to generate a mixed baseband signal. The system may include an amplifier connected to the mixer to amplify the mixed baseband signal and output a first amplified signal. The system may include a processor connected to the amplifier to receive the first amplified signal and to perform a first signal processing operation to detect a presence or an absence of the scattered laser light in the detection region.

The system may have one or more additional aspect. The local oscillator source may be a continuous-wave laser. The local oscillator source may be one of a non-cooperative tunable laser, an optical frequency comb with an engineered spectrum, and/or a continuous wave laser with a time-modulated amplitude and phase. The local oscillator source may be a phase modulator driven by a laser and a waveform generator, wherein the carrier signal generated by the local oscillator source is not continuous wave. The local oscillator source may at least one of (1) phase modulate and/or (2) amplitude modulate the carrier signal that is mixed by the mixer with the raw optical signal.

In various instances of the system the first signal processing operation includes further aspects. In various embodiments, the first signal processing operation may comprise using a convolutional neural network (CNN) to implement the signal processing algorithm via machine learning. In various embodiments, the first signal processing operation may include calculating, by the processor, a power spectral density (PSD) of the first amplified signal. The first signal processing operation may include estimating and correcting, by the processor, sloping in a PSD floor of the PSD of the first amplified signal to generate a filtered signal comprising a processed PSD. The first signal processing operation may include summing the entire processed PSD to generate a first sum. The first signal processing operation may include comparing the first sum to a threshold. The first signal processing operation may include indicating, by the processor, the presence of the scattered laser light in the detection region in response to the first sum exceeding the threshold and indicating, by the processor, the absence of the scattered laser light in the detection region in response to the first sum not exceeding the threshold.

The detailed description of various embodiments herein refers to the accompanying drawings, which show various embodiments by way of illustration. While these various embodiments are described in sufficient detail to enable those skilled in the art to practice the disclosure, it should be understood that other embodiments may be realized and that logical chemical, electrical, and mechanical changes may be made without departing from the spirit and scope of the disclosure. Thus, the detailed description herein is presented for purposes of illustration only and not of limitation.

For example, the steps recited in any of the method or process descriptions may be executed in any suitable order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full, and/or any other possible attachment option. Additionally, any reference to without contact (or similar phrases) may also include reduced contact or minimal contact.

The detailed description of various embodiments herein refers to the accompanying drawings and pictures, which show various embodiments by way of illustration. While these various embodiments are described in sufficient detail to enable those skilled in the art to practice the disclosure, it should be understood that other embodiments may be realized, and that logical and mechanical changes may be made without departing from the spirit and scope of the disclosure. Thus, the detailed description herein is presented for purposes of illustration only and not for purposes of limitation.

For example, the steps recited in any of the method or process descriptions may be executed in any order and are not limited to the order presented. Moreover, any of the functions or steps may be outsourced to or performed by one or more third parties. Modifications, additions, or omissions may be made to the systems, apparatuses, and methods described herein without departing from the scope of the disclosure. For example, the components of the systems and apparatuses may be integrated or separated. An individual component may be comprised of two or more smaller components that may provide a similar functionality as the individual component. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. Furthermore, any reference to singular includes plural embodiments, and any reference to more than one component may include a singular embodiment. Use of ‘a’ or ‘an’ before a noun naming an object shall indicate that the phrase be construed to mean ‘one or more’ unless the context sufficiently indicates otherwise. For example, the description or claims may refer to a processor for convenience, but the invention and claim scope contemplates that the processor may be multiple processors. The multiple processors may handle separate tasks or combine to handle certain tasks. Although specific advantages have been enumerated herein, various embodiments may include some, none, or all of the enumerated advantages. A “processor” may include hardware that runs the computer program code. Specifically, the term ‘processor’ may be synonymous with terms like controller and computer and should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices.

Systems, methods, and computer program products are provided. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

The system may allow users and/or electronic devices (collectively, “users”) to access data, and receive updated data in real time from other users. The system may store the data (e.g., in a standardized format) in a plurality of storage devices, provide remote access over a network so that users may update the data in a non-standardized format (e.g., dependent on the hardware and software platform used by the user) in real time through a GUI, convert the updated data that was input (e.g., by a user) in a non-standardized form to the standardized format, automatically generate a message (e.g., containing the updated data) whenever the updated data is stored and transmit the message to the users over a computer network in real time, so that the user has immediate access to the up-to-date data. The system allows remote users to share data in real time in a standardized format, regardless of the format (e.g., non-standardized) in which the user inputted the information. The system may also include a filtering tool that is remote from the end user and provides customizable filtering features to each end user. The filtering tool may provide customizable filtering by filtering access to the data. The filtering tool may identify data or accounts that communicate with the server and may associate a request for content with the individual account, user, device, etc. The system may include a filter on a local computer and a filter on a server.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As used herein, “satisfy,” “meet,” “match,” “associated with,” or similar phrases may include an identical match, a partial match, meeting certain criteria, matching a subset of data, a correlation, satisfying certain criteria, a correspondence, an association, an algorithmic relationship, and/or the like. Similarly, as used herein, “authenticate” or similar terms may include an exact authentication, a partial authentication, authenticating a subset of data, a correspondence, satisfying certain criteria, an association, an algorithmic relationship, and/or the like.

Terms and phrases similar to “associate” and/or “associating” may include tagging, flagging, correlating, using a look-up table or any other method or system for indicating or creating a relationship between elements. Moreover, the associating may occur at any point, in response to any suitable action, event, or period of time. The associating may occur at pre-determined intervals, periodically, randomly, once, more than once, or in response to a suitable request or action. Any of the information may be distributed and/or accessed via a software enabled link, wherein the link may be sent via an email, text, post, social network input, and/or any other method.

As used herein, “electronic communication” means communication of electronic signals with physical coupling (e.g., “electrical communication” or “electrically coupled”) or without physical coupling and via an electromagnetic field (e.g., “inductive communication” or “inductively coupled” or “inductive coupling”) and/or a radio frequency (RF) communications protocol. In this regard, “electronic communication,” as used herein, includes wired and wireless communications (e.g., Bluetooth, Bluetooth LE, NFC, TCP/IP, Wi-Fi, etc.).

Any databases discussed herein may include relational, hierarchical, graphical, blockchain, object-oriented structure, and/or any other database configurations. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2® by IBM® (Armonk, NY), various database products available from ORACLE® Corporation (Redwood Shores, CA), MICROSOFT ACCESS® or MICROSOFT SQL SERVER® by MICROSOFT® Corporation (Redmond, Washington), MYSQL® by MySQL AB (Uppsala, Sweden), MONGODB®, Redis, Apache Cassandra®, HBASE® by APACHE®, MapR-DB by the MAPR® corporation, or any other suitable database product. Moreover, any database may be organized in any suitable manner, for example, as data tables or lookup tables. Each record may be a single file, a series of files, a linked series of data fields, or any other data structure.

As used herein, data may refer to partially or fully structured, semi-structured, or unstructured data sets including “big data,” which may include millions of rows and hundreds of thousands or millions of columns.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

One skilled in the art will also appreciate that, for security reasons, any databases, systems, devices, servers, or other components of the system may comprise or consist of any combination thereof at a single location or at multiple locations, wherein each database or system includes any of various suitable security features, such as firewalls, access codes, encryption, decryption, public and private keys, and/or the like.

As used herein, a “script” refers to instructions for a computing device to carry out one or more tasks automatically. As used herein, the term “network” includes any cloud, cloud computing system, or electronic communications system or method which incorporates hardware and/or software components. Communication among the parties may be accomplished through any suitable communication channels, such as, for example, a telephone network, an extranet, an intranet, internet, personal internet device, online communications, satellite communications, off-line communications, wireless communications, transponder communications, local area network (LAN), wide area network (WAN), virtual private network (VPN), networked or linked devices, keyboard, mouse, and/or any suitable communication or data input modality. Moreover, although the system may be described herein as being implemented with TCP/IP communications protocols, the system may also be implemented using IPX, APPLETALK®, IPV6, NetBIOS, any tunneling protocol (e.g., IPsec, SSH, etc.), or any number of existing or future protocols. If the network is in the nature of a public network, such as the internet, it may be advantageous to presume the network to be insecure and open to eavesdroppers. Specific information related to the protocols, standards, and application software utilized in connection with the internet is generally known to those skilled in the art and, as such, need not be detailed herein.

“Cloud” or “Cloud computing” or “cloud computing infrastructure” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. Reference to a “device” or processor or memory or the like may include cloud resources, non-cloud resources, or combinations of cloud and non-cloud resources.

Computer programs (also referred to as computer control logic) are stored in main memory and/or secondary memory. Computer programs may also be received via communications interface. These computer program instructions may be loaded onto a general purpose computer, special purpose computer, controller, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer, controller, or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

In various embodiments, software may be stored in a computer program product and loaded into a computer system using a removable storage drive, hard disk drive, or communications interface. The control logic (software), when executed by the processor or controller, causes the processor or controller to perform the functions of various embodiments as described herein. In various embodiments, hardware components may take the form of application specific integrated circuits (ASICs). Implementation of the hardware so as to perform the functions described herein will be apparent to persons skilled in the relevant art(s).

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment (e.g., an internet-based driving command system), an entirely hardware embodiment, or an embodiment combining aspects of the internet, software, and hardware. Furthermore, the system may take the form of a computer program product on a computer-readable storage medium having computer-readable program code means embodied in the storage medium. Any suitable computer-readable storage medium may be utilized, including hard disks, solid state storage media, CD-ROM, BLU-RAY DISC®, optical storage devices, magnetic storage devices, and/or the like.

The system and method may be described herein in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT®, JAVASCRIPT® Object Notation (JSON), VBScript, Macromedia COLD FUSION, COBOL, MICROSOFT® company's Active Server Pages, assembly, PERL®, PHP, awk, PYTHON®, Visual Basic, SQL Stored Procedures, PL/SQL, any UNIX® shell script, and extensible markup language (XML) with the various algorithms being implemented with any combination of data structures, objects, processes, routines or other programming elements. Further, it should be noted that the system may employ any number of techniques for data transmission, signaling, data processing, network control, and the like. Still further, the system can be used to detect or prevent security issues with a client-side scripting language, such as JAVASCRIPT®, VBScript, or the like.

The system and method are described herein with reference to screen shots, block diagrams and flowchart illustrations of methods, apparatus, and computer program products according to various embodiments. It will be understood that each functional block of the block diagrams and the flowchart illustrations, and combinations of functional blocks in the block diagrams and flowchart illustrations, respectively, can be implemented by computer program instructions.

In various embodiments, components, modules, and/or engines of the systems may be implemented as applications or apps. Apps are typically deployed in the context of a mobile operating system, including for example, a WINDOWS® mobile operating system, an ANDROID® operating system, an APPLE® iOS operating system, a BLACKBERRY® company's operating system, and the like. The app may be configured to leverage the resources of the larger operating system and associated hardware via a set of predetermined rules which govern the operations of various operating systems and hardware resources. For example, where an app desires to communicate with a device or network other than the mobile device or mobile operating system, the app may leverage the communication protocol of the operating system and associated device hardware under the predetermined rules of the mobile operating system. Moreover, where the app desires an input from a user, the app may be configured to request a response from the operating system which monitors various hardware components and then communicates a detected input from the hardware to the app.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows, and the descriptions thereof may refer to user WINDOWS®/LINUX®/UNIX® applications, webpages, websites, web forms, prompts, etc. Practitioners will appreciate that the illustrated steps described herein may comprise, in any number of configurations, including the use of WINDOWS®/LINUX®/UNIX® applications, webpages, web forms, popup WINDOWS®/LINUX®/UNIX® applications, prompts, and the like. It should be further appreciated that the multiple steps as illustrated and described may be combined into single webpages and/or WINDOWS®/LINUX®/UNIX® applications but have been expanded for the sake of simplicity. In other cases, steps illustrated and described as single process steps may be separated into multiple webpages and/or WINDOWS®/LINUX®/UNIX® applications but have been combined for simplicity.

The computers discussed herein may provide a suitable website or other internet-based graphical user interface (GUI) which is accessible by users. In one embodiment, MICROSOFT® company's Internet Information Services (IIS), Transaction Server (MTS) service, and an SQL SERVER® database, are used in conjunction with MICROSOFT® operating systems, WINDOWS NT® web server software, SQL SERVER® database, and MICROSOFT® Commerce Server. Additionally, components such as ACCESS® software, SQL SERVER® database, ORACLE® software, SYBASE® software, INFORMIX® software, MYSQL® software, INTERBASE® software, etc., may be used to provide an Active Data Object (ADO) compliant database management system. In one embodiment, the APACHE® web server is used in conjunction with a LINUX® operating system, a MYSQL® database, and PHP, Ruby, and/or PYTHON® programming languages.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching may be used throughout the figures to denote different parts but not necessarily to denote the same or different materials.

Methods, systems, and articles are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A method for coherent detection for identification of scattered laser light by an optical sensor connected to a processor, the method comprising:
collecting a raw optical signal by the optical sensor;
applying a first high pass filter to the raw optical signal to generate a first filtered signal;
calculating, by the processor, a power spectral density (PSD) of the first filtered signal;
estimating and correcting, by the processor, sloping in a PSD floor of the PSD of the first filtered signal to generate a second filtered signal;
determining a location of maximum value in the second filtered signal;
summing around the location with a fixed window size to generate a first sum;
comparing the first sum to a threshold; and
indicating, by the processor, a presence of a laser creating the scattered laser light in response to the first sum exceeding the threshold.

2. The method of claim 1, wherein the first high pass filter has a cut-off of about 1 MHz.

3. The method of claim 1, wherein the first high pass filter has a cut-off selected to remove lower frequency components that cause an unwanted spike in PSD in an absence of the laser.

4. The method of claim 1, wherein the first high pass filter is a hardware-based filter.

5. The method of claim 1, wherein the first high pass filter is a software-based filter implemented by the processor.

6. The method of claim 1, wherein the estimating and correcting comprises taking a rolling average of measured PSD and subtracting PSD by the rolling average.

7. The method of claim 1, wherein the estimating and correcting comprises using a calibration measurement from a separate signal known to omit scattered laser light to determine the PSD floor.

8. A method for coherent detection for identification of scattered laser light by an optical sensor connected to a processor, the method comprising:
collecting a raw optical signal by the optical sensor;
applying a first high pass filter to the raw optical signal to generate a first filtered signal;
calculating, by the processor, a power spectral density (PSD) of the first filtered signal;
estimating and correcting, by the processor, sloping in a PSD floor of the PSD of the first filtered signal to generate a second filtered signal comprising a processed PSD;
summing the entire processed PSD to generate a first sum;
comparing the first sum to a threshold; and
indicating, by the processor, a presence of a laser creating the scattered laser light in response to the first sum exceeding the threshold.

9. The method of claim 8, wherein the first high pass filter has a cut-off of about 1 MHz.

10. The method of claim 8, wherein the first high pass filter has a cut-off selected to remove lower frequency components that cause an unwanted spike in PSD in an absence of an active laser.

11. The method of claim 8, wherein the first high pass filter is at least one of: (a) a hardware-based filter; or (b) a software-based filter implemented by the processor.

12. The method of claim 8, wherein the estimating and correcting comprises taking a rolling average of measured PSD and subtracting PSD by the rolling average.

13. The method of claim 8, wherein the estimating and correcting comprises using a calibration measurement from a separate signal known to omit scattered laser light to determine the PSD floor.

14. A system for coherent detection for identification of scattered laser light in a detection region, the system comprising:
an optical sensor to collect a raw optical signal;
a mixer connected to the optical sensor to mix the raw optical signal with a carrier signal generated by a local oscillator source to generate a mixed baseband signal;
an amplifier connected to the mixer to amplify the mixed baseband signal and output a first amplified signal; and
a processor connected to the amplifier to receive the first amplified signal and to perform a first signal processing operation to detect a presence or an absence of the scattered laser light in the detection region.

15. The system according to claim 14, wherein the first signal processing operation comprises implementing a convolutional neural network (CNN) via machine learning.

16. The system according to claim 14, wherein the local oscillator source is a continuous-wave laser.

17. The system according to claim 14, wherein the local oscillator source comprises one of a non-cooperative tunable laser, an optical frequency comb with an engineered spectrum, or a continuous wave laser with a time-modulated amplitude and phase.

18. The system according to claim 14, wherein the local oscillator source comprises a phase modulator driven by a laser and a waveform generator, wherein the carrier signal generated by the local oscillator source is not continuous wave.

19. The system according to claim 14, wherein the local oscillator source at least one of (1) phase modulates or (2) amplitude modulates the carrier signal that is mixed by the mixer with the raw optical signal.

20. The system according to claim 14, wherein the first signal processing operation comprises:
calculating, by the processor, a power spectral density (PSD) of the first amplified signal;
estimating and correcting, by the processor, sloping in a PSD floor of the PSD of the first amplified signal to generate a filtered signal comprising a processed PSD;
summing the entire processed PSD to generate a first sum;
comparing the first sum to a threshold; and
indicating, by the processor, the presence of the scattered laser light in the detection region in response to the first sum exceeding the threshold and indicating, by the processor, the absence of the scattered laser light in the detection region in response to the first sum not exceeding the threshold.
